(19) United States
(12) Patent Application Publication
(10) Pub. No.: US 2009/0160739 A1
(43) Pub. Date: Jun. 25, 2009

(54) Plasma Display panel and plasma display

(76) Inventors: Takayuki Kobayashi, Kunitomi (JP); Takashi Sasaki, Kunitomi (JP); Naoki Itokawa, Kunitomi (JP); Tooru Teraoka, Kunitomi (JP)

Correspondence Address: MCDERMOTT WILL & EMERY LLP, 600 13TH STREET, N.W., WASHINGTON, DC, 20005-3096, US

(21) Appl. No.: 11/919,628

(22) PCT Filed: Aug. 26, 2005
(86) PCT No.: PCT/JP2005/015574

§ 371 Date: Sep. 4, 2008

(51) Int. Cl. G09G 3/28

(52) U.S. Cl. 345/60

(57) ABSTRACT

A technology for the four-electrode type PDP for preventing the lowering of luminance depending on the display load ratio due to the voltage drop at electrode by mitigating concentration of discharge timing. On a front substrate of a PDP (10), a first (X) electrode, a second (Y) electrode, and a third (Z) electrode therebetween are arranged in parallel in a first direction. Between Substrates, barrier ribs for sectioning cells 3 of respective colors of R, G, B and phosphor layers of respective colors are provided. In the respective cells (3), an interval of the X, Y electrodes is roughly constant. It is a structure where intervals between the X, Y electrodes and the Z electrode (XZ, YZ) are different. Particularly, an interval of R is narrow and an interval of B is wide.

### TECHNICAL FIELD

The present invention relates to a technique relating to a display panel and driving for various applications, such as display devises for personal computers and work stations and the like, flat wall-hanging TV sets, and displays for advertisement and information and the like. More particularly, the present invention relates to a technique of an AC type plasma display panel (hereinafter, abbreviated as PDP), a PDP module structured by including the PDP and a driver circuit and the like, and a PDP apparatus (plasma display device) including the PDP module.

### BACKGROUND ART

In recent years, 3-electrode PDPs have been widely used. The 3-electrode PDP generally has a structure where X electrodes and Y electrodes are arranged in parallel alternately in a first direction on a first substrate, address electrodes which expand so as to cross in a direction vertical to the X, Y electrodes in the first direction are arranged on a second substrate opposing the first substrate, and the respective surfaces of the electrodes are covered with a dielectric layer. Further, on the second substrate, stripe-shaped ribs which expand in parallel between the address electrodes or 2-dimensional grid ribs which are arranged so as to lay out cells are provided. Phosphor layers are formed between the ribs, and the first and the second substrates are sticked together.

Moreover, as a 4-electrode PDP, there is a proposed structure where, in addition to the X, Y, and address electrodes, Z electrodes are further provided in parallel between the X, Y electrodes. By providing the Z electrodes, it may be used for, for example, trigger actions, discharge prevention in nondisplay lines, reset actions and the like.

As the conventional PDP technique, there is a structure which particularly relates to electrode structures including different pitch products (for example, a structure where lateral pitches differ in cells according to respective colors R, G, B) and a structure where the areas of the X, Y electrodes for sustain discharge are changed. With regard to the 4-electrode PDP, a technique described in Patent Document 1 is an example in which rib pitches and the area of the fourth electrode (electrodes for address discharge) are changed. With regard to the 3-electrode PDP, a technique described in Patent Document 2 is an example in which the width of the transparent electrodes (discharge electrodes) is changed.

Patent Document 1: Japanese Patent Application Laid-Open Publication No. 2000-113821

Patent Document 2: Japanese Patent Application Laid-Open Publication No. 2002-56781

### DISCLOSURE OF THE INVENTION

In the PDPs, luminance lowering depending on the display load ratio due to voltage drop at electrodes becomes a problem. This is a phenomenon that the flowing current increases instantaneously by concentration of discharge timing and the voltage drop at long and thin electrodes becomes large. In particular, when the display load ratio is large, the amount of voltage drop becomes large and it leads to uneven luminance.

According to the technique of Patent Document 2, it is possible to increase the color temperature of white by changing the widths of the X, Y electrodes per color. However, since the interval between the X, Y electrodes is fixed, it is not possible to delay the discharge timing.

The present invention was made in consideration of the above problems in the prior art. Accordingly, an object of the present invention is to provide a technique in the techniques of 4-electrode PDP, PDP module, plasma display apparatus and the like for easing the concentration of the discharge timing so that preventing the luminance lowering depending on the display load ratio due to the voltage drop in the electrodes.

The typical ones of the inventions disclosed in this application will be briefly described as follows. In order to achieve the above object, according to one aspect of the present invention, there are provided a 4-electrode PDP (panel device) or a PDP module equipped with a PDP and driver circuits (drivers) and the like or a plasma display device (PDP apparatus) equipped with the PDP module and the like having the following technical means and structures.

The present PDP has the following structure with a configuration including: first (X) electrodes of a 4-electrode structure, namely, which are arranged roughly in parallel and perform sustain discharge; second (Y) electrodes capable of scan and drive independently; third (Z) electrodes arranged between the X, Y electrodes; a first substrate (front substrate) having dielectric layers and protective layers to cover the X, Y, Z electrodes; and a second substrate (back substrate) having fourth (A) electrodes for address drive arranged so as to cross in a roughly vertical direction to the X, Y electrodes.

In the present PDP, in a plurality of cells as the minimum unit of light emission, intervals (XZ, YZ) of the plurality of electrodes (X, Z, Y) for discharge in the first substrate are provided so as to be slightly different. In particular, in a structure having cells of respective colors of R (red), G (green), B (blue) to be a plurality of subpixels composing pixels as a plurality of adjacent cells, in the cells of the respective colors, the intervals of the respective electrodes (X, Y, Z), that is, the distances of discharge gaps are made different. In the structure of the present PDP, in the respective cells, the interval (XY) of the X, Y electrodes is roughly constant, and in the cells of at least one color, at least one of the cells of the plurality of respective colors, the intervals (XZ, YZ) between the X, Y electrodes and the Z electrodes are made different from that in the cells of other colors. For example, as for the intervals (XZ, YZ) of the cells of the respective colors of R, G, B in the first direction, different intervals are specified per color.

According to the structure of the present PDP, in the case where a voltage for sustain discharge driving is applied to the plurality of cells having these different intervals (XZ, YZ) from the driver side, since the intervals (XZ, YZ) are different in the respective cells in the structure, firing voltages differ therebetween, and firing timing is distributed bit by bit. Therefore, such the concentration of discharge timing as in the prior art is eased and accordingly the increase of the current to instantaneously flow in the electrodes is eased and the voltage drop is controlled and reduced. Consequently, it is possible to cope with the luminance lowering depending on the display load ratio dependence due to the voltage drop, and to prevent uneven luminance in the plurality of cells. More details are described below.

(1) A first substrate (front substrate) and a second substrate (back substrate) which is arranged so as to oppose the first substrate and forms a discharge space filled with discharge gas between the first substrate and itself are comprised. The first substrate has a plurality of first, second, third electrodes in parallel which expand in a first direction, and these electrodes are covered with a dielectric layer. The second substrate has a plurality of fourth electrodes (address electrodes) in parallel which expand in a second direction crossing the first direction, and these electrodes are covered with a dielectric layer. A voltage is applied from a driver side to the respective electrodes. Between the first and the second substrates (discharge space), a barrier rib which sections areas corresponding to the cells to become the minimum unit of light emission is arranged so as to expand in at least the second direction. In the plurality of areas sectioned by the barrier rib, in the first direction and in sequence, phosphor layers of the plurality of respective colors R, G, B are arranged in correspondence. According to the plurality of adjacent cells, a pattern of the plurality of colors is repeated.

The first and second electrodes are arranged roughly in parallel. The third electrodes are arranged between the first and the second electrodes, and for sustain discharge, it is configured to have a set of three electrodes of first, third, second (positive slits) (corresponding to normal method), and in addition, it is also configured to have a set of three electrodes of second, third, first (reverse slits) (corresponding to so-called ALIS method).

In a physical structure of electrode shape and the like, in each of the cells, an interval between the first and the second electrodes (referred to as XY, and the interval of other electrodes will be expressed in the same manner) is roughly constant over the entire PDP display area, and the intervals (XZ, YZ) between the third electrodes and the first and the second electrodes at both sides thereof are different according to the colors. The intervals (XZ, YZ) in at least one color of the plurality of colors are set so as to be different from the similar intervals in other colors.

For example, the X, Y electrodes, respectively, have a transparent electrode that transmits the visible light (also referred to as a discharge electrode), and a bus electrode that contacts the transparent electrode being a straight-line shape and whose resistance value is lower than that of the transparent electrode (also referred to as a metal electrode). Each transparent electrode has a protruding portion from the bus electrode to the second direction. The protruding portion determines an interval to the adjacent electrodes, that is, a discharge gap. For example, in a sustain discharge, a trigger discharge is performed between the Z electrode and Y or X electrode (YZ or XZ), and then a main discharge is performed between the X and Y electrodes (XY).

(2) For example, the Z electrode includes a transparent electrode that transmits the visible light (discharge electrode) and a bus electrode whose resistance value is lower than that of the transparent electrode (metal electrode). An edge opposing the X, Y electrodes at the protruding portion protruding towards the second direction of the Z transparent electrode is roughly in parallel with edges of the X, Y electrodes. The protruding portion of the Z transparent electrode in the cells of the respective colors is rectangular, and since the lengths of the protrusions in the second direction differ, the difference of the intervals (XZ, YZ) is made. A voltage is applied from the driver side to the electrode group of the PDP and a discharge occurs between edges of the protruding portions of respective transparent electrodes.

(3) For example, an edge opposing the X, Y electrodes at the protruding portion towards the second direction of the Z transparent electrode is in a shape having a specified angle to the edges of the X, Y electrodes. The protruding portion of the Z transparent electrode in the cells of the respective colors is triangular, and the angles thereof differ so that the difference of the intervals (XZ, YZ) is made.

(4) In particular, in the cells of the plurality of respective colors, the intervals (XZ, YZ) between the X, Y electrodes and the Z electrode in a cells of the colors where the discharge voltage (firing voltage) is the lowest, that is the cell of R, are structured so as to be narrower than the similar intervals in the cells of other colors.

(5) In particular, in the cells of the plurality of respective colors, the intervals (XZ, YZ) between the X, Y electrodes and the Z electrode in the cell of B are structured so as to be wider than the similar intervals in the cells of other colors.

The effects obtained by typical aspects of the present invention will be briefly described below. According to the present invention, in the 4-electrode PDP, it is possible to distribute discharge timing of respective cells particularly in a sustain discharge, so that the luminance lowering due to the voltage drop is eased and prevented. Therefore, it is possible to keep the luminance of the respective cells roughly constant irrespective of the display load ratio, i.e., it is possible to prevent uneven luminance.

### BRIEF DESCRIPTIONS OF THE DRAWINGS

FIG. 1 is a block diagram showing a PDP and driver circuits as a structure of a PDP apparatus according to an embodiment of the present invention;

FIG. 2 is an exploded perspective view showing a part of the PDP according to the embodiment of the present invention;

FIG. 3 is a diagram showing a detailed structure of cells and electrodes of a PDP in a PDP apparatus according to a first embodiment of the present invention;

FIG. 4 is a diagram showing a structure of an embodiment corresponding to a normal method in which intervals of respective electrodes corresponding to rows of the PDP in FIG. 3 and Z electrodes are arranged on only a positive slit side according to the PDP divide according to the first embodiment of the present invention;

FIG. 5 is a diagram showing Driving Waveforms of one subfield, in a PDP apparatus according to the first embodiment of the present invention;

FIG. 6 is a diagram showing conditions of discharge, current and voltage in the case when one time of sustain discharge is occurred between X, Y electrodes in a 3-electrode PDP as a supposed technique for comparison with the present embodiment;

FIG. 7 is a diagram showing conditions of discharge, current and voltage in the case when one time of sustain discharge is occurred between X, Z, Y electrodes in the PDP apparatus according to the first embodiment of the present invention;

FIGS. 8A and 8B are diagrams showing Paschen curves and setting range of design specifications in the first embodiment of the present invention; and

FIG. 9 is a diagram showing detailed structures of cells and electrodes of a PDP in a PDP apparatus according to a second embodiment of the present invention.

### BEST MODE FOR CARRYING OUT THE INVENTION

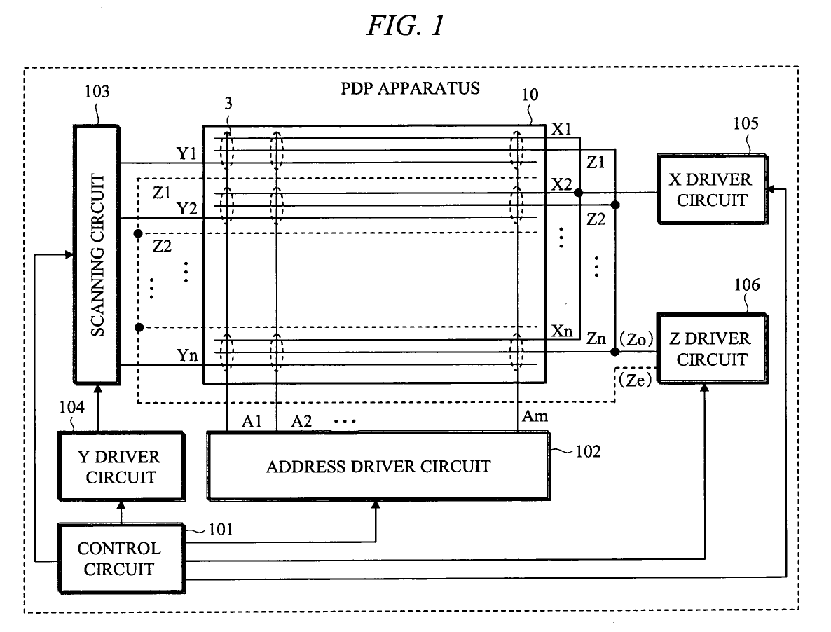

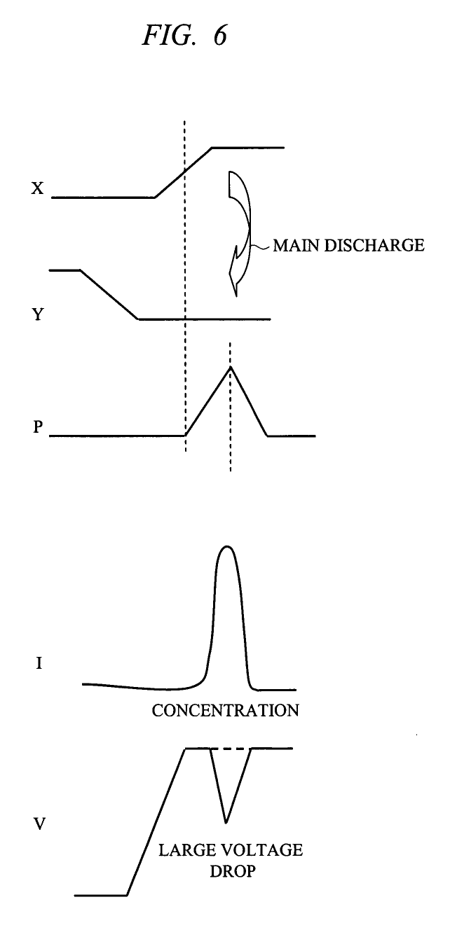

Hereinafter, embodiments of the present invention will be described in detail with reference to the accompanying drawings. Note that components having the same function are denoted by the same reference symbols throughout the drawings for describing the embodiment, and the repetitive description thereof will be omitted. FIGS. 1 to 5 and FIGS. 7 to 9 are diagrams for describing embodiments of the present invention. FIG. 6 is a diagram for describing a supposed technique for a comparison with the present embodiments.

### First Embodiment

The outline of a PDP apparatus according to a first embodiment is as described below. In a structure of a PDP having first (X), second (Y), third (Z), fourth (A) electrodes, respective bus electrodes of X, Y, Z are arranged roughly in parallel in a straight line shape, discharge electrodes of X, Y are made into a same shape, and the shape of a discharge electrode of the Z electrode is made different. Per cells of the respective colors of R, G, B which are adjacent in a lateral direction (first direction), intervals (XZ, YZ) between the Z electrode and the X, Y electrodes, in particular, distances between edges of the respective discharge electrodes are made different. In particular, among R, G, B, the intervals (XZ, YZ) in R are made narrow, and the intervals (XZ, YZ) in B are made wide. In other words, it is a configuration where a firing voltage for a sustain discharge is higher in the order of R, G, B. In particular, in the first embodiment, the shape of the discharge electrode of the Z electrode per cell is made to be rectangular, and the edges thereof and the edges of opposing electrodes are made to be roughly in parallel. In the line (first direction) of the bus electrode, it is configured to have a comb-tooth shape formed of a pattern of rectangular protruding portions in different sizes is arranged.

<PDP and Driver>

FIG. 1 is a block diagram showing a PDP 10 and drivers as a structure of the PDP apparatus according to the first embodiment of the present invention. The PDP 10 used in the PDP apparatus according to the first embodiment is a 4-electrode PDP in which a discharge takes place in a cell 3 comprising a set of first (X), second (Y), third (Z), and fourth (A) electrodes.

The hardware composition of the entire PDP apparatus is structured by a chassis, a PDP, driver modules and the like. The driver module is a portion where circuits such as driver circuit (driver) and the like are packaged as an IC chip on a flexible substrate and modularized. The PDP is connected and fixed to the chassis. The driver modules are connected to PDP terminals and terminals of a back side substrate of the chassis. On the back side substrate of the chassis, a control circuit, a power circuit and the like are packaged.

In FIG. 1, the present PDP apparatus includes a control circuit 101, an address driver 102, a scan driver 103, a Y driver 104, an X driver 105, and a Z driver 106.

The control circuit 101 controls respective components including the respective drivers and controls the display of the PDP 10. The control circuit 101 outputs control signals to control the display actions to the respective drivers on the basis of data signals and the like inputted from the external. The respective drivers, on the basis of the control signals from the control circuit 101, give Driving Waveforms to the electrodes of the PDP 10. The address driver 102 drives m pieces of address electrodes. The scan driver 103 applies a scan pulse to n pieces of Y electrodes. The Y driver 104 applies a voltage other than the scan pulse to the n pieces of Y electrodes via the scan driver 103. The X driver 105 commonly applies a voltage to n pieces of X electrodes. The Z driver 106 commonly applies a voltage to n pieces of Z electrodes (in the case of positive slit side Zo). With regard to the Z electrodes, a configuration where driving can be made by positive and reverse slits (Zo, Ze), so-called ALIS method driving can be made is shown. On the address electrodes and the Y electrodes, address operations are performed, and on the X, Y, Z electrodes, sustain discharge operations are performed.

In the PDP 10, the first (X) electrodes X {X1 to Xn} and the second (Y) electrodes Y {Y1 to Yn} expanding in a straight line in the lateral direction (first direction) of the panel surface are arranged alternately, and between the X, Y electrodes (XY) of each pair at the positive slit side, the third (Z) electrodes Z {Z1 to Zn} are arranged. There are formed n sets of three electrodes (X, Z, Y). Further, fourth electrodes A {A1 to Am} as address electrodes expanding in a straight line in the longitudinal direction (second direction) of the panel surface are arranged so as to cross the n sets of the electrodes, and the crossing portions thereof become the cells 3. Therefore, the cells 3 made of n pieces of display rows and m pieces of display columns are formed therein.

With regard to the Z electrodes, odd-number rows of electrodes Zo {Z1, . . . , Zn} are arranged at the positive slit side, and even-number rows of electrodes Ze {Z1, Z2, . . . } are arranged at the reverse slit side thereof. That is, the respective electrodes (X, Y, Z) are arranged in sequence as {X, Zo, Y, Ze, X, Zo, Y, Ze . . . }. The electrode structure of the present embodiment is not limited to this ALIS method, but may be applied in the same manner to an embodiment corresponding to the normal method where driving can be made only at the positive slit side. In this case, the respective electrodes (X, Y, Z) are arranged in sequence as {X1, Z1, Y1, X2, Z2, Y2 . . . }.

The driving of the ALIS method is well known to those skilled in the art and so detailed descriptions thereof are omitted herein. The number of the Z electrodes is approximately twice the number of the X, Y electrodes. In the ALIS method, all the portions between the X, Y electrodes may be used as display lines. In particular, an interlace display control can be performed at the odd-number line side (Zo) and the even-number line side (Ze). The respective electrodes are made into groups and driven from the driver sides respectively.

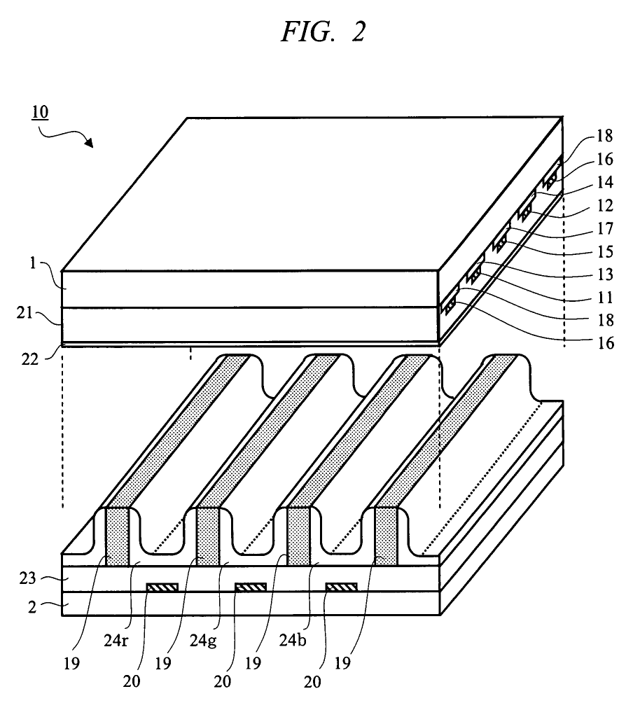

FIG. 2 is an exploded perspective view showing a part of the PDP according to the first embodiment of the present invention. In a front substrate 1 as a first substrate, the first (X) electrodes, the third (Z) electrodes, and the second (Y) electrodes are arranged in sequence as {Ze, X, Zo, Y, Ze . . . }. In a back substrate 2 as a second substrate, the fourth (A) electrodes (address electrodes) are arranged.

Across the full width of the panel of the PDP 10 of the front substrate 1, as shown in the dot line, an X bus electrode 12, a Y bus electrode 11, Z bus electrodes 15, 16 are arranged. The length of the respective bus electrodes is several ten cm or more, and the interval between the X, Y electrodes is several hundred μm.

The X electrode is structured by a first (X) transparent electrode (also referred to as discharge electrode) 14 and a first (X) bus electrode 12. In the same manner, the Y electrode is structured by a second (Y) transparent electrode (discharge electrode) 13 and a second (Y) bus electrode 11. The Z electrode at the positive slit side is structured by a third (Z) transparent electrode (discharge electrode) 17 and a third (Z) bus electrode 15. Further, the Z electrode at the reverse slit side is structured by a third (Z) transparent electrode (discharge electrode) 18 and a third (Z) bus electrode 16.

On the front substrate 1, the X bus electrode 12 and the Y bus electrode 11 expanding in a straight line in the lateral direction (first direction) are arranged alternately in parallel and make pairs. And, the X, Y transparent electrodes 12, 11 are arranged so as to overlap the X, Y bus electrodes 14, 13. Between a pair of the X, Y bus electrodes 14, 13, the Z transparent electrode 17 and the Z bus electrode 15 are arranged so as to overlap in the same manner.

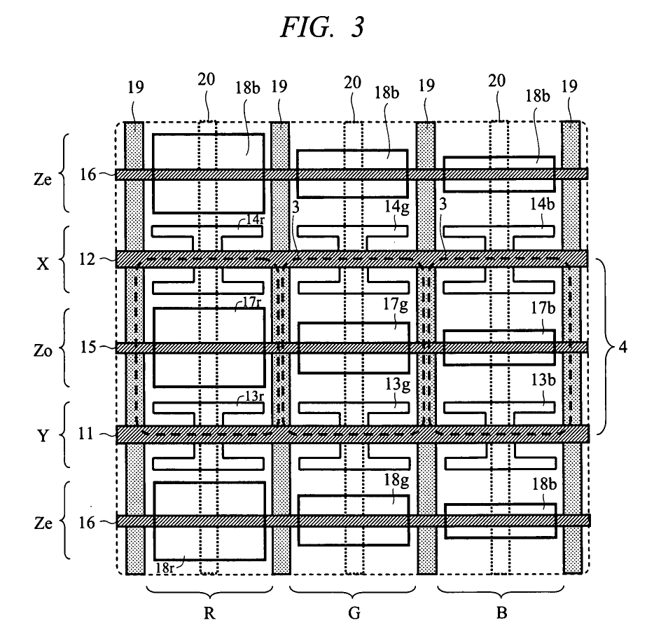

Parts of the X, Y transparent electrodes 14, 13 are respectively shaped to expand as protruding portions from the lines of the respective bus electrodes (11, 12) towards the respective Z electrodes opposing in the second direction. In the same manner, parts of the Z transparent electrodes 17, 18 are respectively shaped to expand as protruding portions from the lines of the respective bus electrodes (15, 16) towards the respective X, Y electrodes opposing in the second direction. The detail thereof is shown with reference to FIG. 3.

For example, the respective bus electrodes (12, 11, 15, 16) are formed of a metal layer. The respective transparent electrodes (14, 13, 17, 18) are formed of an ITO (indium tin oxide) layer film to be optically transparent and the like. The resistance value of the respective bus electrodes is lower than or same as the resistance value of the respective transparent electrodes.

In the front substrate 1, a dielectric layer 21 is formed so as to cover the respective bus electrodes and transparent electrodes. The dielectric layer 21 is formed of a silicon oxide (SiO2) film or the like that is formed by the chemical vacuum deposition (CVD) and transmits visible light. Further, in the case where the CVD is not used, in order to make the panel capacity small, the thickness of the dielectric layer 21 is made to be, for example, 25 μm or below. Furthermore, in order to prevent the insulation breakdown by foreign matters and the like, it is preferable that the thickness of the dielectric layer 21 is 3 μm or more. On this dielectric layer 21, a protective layer 22 is further formed. The protective layer 22 is formed of magnesium oxide (MgO) and the like. Moreover, the discharge gas of discharge space has a composition including at least Ne and Xe, and the mixture rate of Xe is made to be 10% or more. Further, in order to prevent increase of drive voltage, the mixture rate of Xe is preferably 30% or below. Note that, the embodiment where the Z electrode layer is formed in the same layer as that of the X, Y electrode layers, however, the Z electrode layer may be formed in other layers different from the X, Y electrode layers. Through the front substrate 1 described above, light emission of the cells 3 is seen.

On the back substrate 2, address electrodes 20 as fourth electrodes are arranged so as to cross the respective bus electrodes. The address electrodes 20 are formed of, for example, a metal layer. On the address electrode group 20, a dielectric layer 23 is formed.

Further, between the front substrate 1 and the back substrate 2, on the side surfaces and the bottom surfaces of slots formed by barrier ribs (ribs) 19 and the dielectric layer 23, phosphor layers 24 {24r, 24g, 24b} of the respective colors R, G, B are applied separately so as to be repeated in sequence. The respective phosphor layers 24 are excited by an ultraviolet ray that appears at discharges in the cells 3 and generate visible light of corresponding R, G, B. By the set of three cells corresponding to the subpixels of R, G, B, one pixel is structured. In the assembly process of the PDP 10, the front substrate 1 and the back substrate 2 are overlapped, air is evacuated, and discharge gas is filled in the discharge space and sealed.

<Electrode Structure>

FIG. 3 is a diagram showing a detailed structure of cells and electrodes of the PDP 10 in the PDP apparatus according to the first embodiment of the present invention. In particular, it shows three columns of cells 3 corresponding to the subpixels of the respective colors (R, G, B) adjacent in the lateral direction (first direction) of the panel surface. FIG. 3 shows the case where the Z electrodes (Zo and Ze) are arranged in both the positive and reverse slits, in correspondence to FIG. 1 and FIG. 2. In the longitudinal direction, a row 4 of one set of electrodes (X, Zo, Y) at the positive slit side and the Z electrode (Ze) at the reverse slit side adjacent thereto are shown.

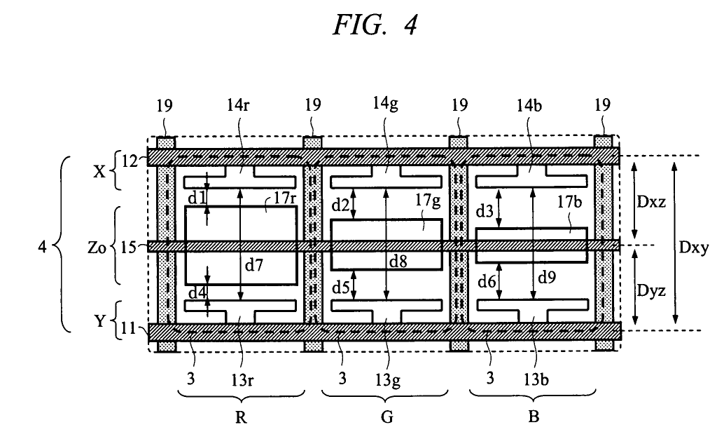

FIG. 4 shows the intervals of the respective electrodes corresponding to the row 4 in FIG. 3. Further, FIG. 4 corresponds to a structure in a form corresponding to the normal method where the Z electrodes are not arranged on both the positive and reverse slits, but arranged on only the positive slit side.

In FIG. 3, space areas sectioned by the rib 19 and the X, Y bus electrodes 12, 11 respectively correspond to the cells 3 of the respective colors R, G, B. In the longitudinal direction, the position of the address electrode 20 at the back substrate 2 side is shown by the dot line. Also in the portion (reverse slit) between rows adjacent to (X, Zo, Y) of the row 4, the Z electrode (Zc) is arranged, and both the positive and reverse slits have the same electrode structure. Between the ribs 19, the address electrode 20 is arranged so as to cross the X, Y electrodes.

The X electrode has X transparent electrodes 14r, 14g, 14b in correspondence to the cells 3 of the respective colors on the line of the X bus electrode 12. In the same manner, the Y electrode has Y transparent electrodes 13r, 13g, 13b in correspondence to the cells 3 of the respective colors on the line of the Y bus electrode 11. The X, Y transparent electrodes 14, 13 are roughly in the same shape.

The Z electrode (Zo) at the positive slit side has Z transparent electrodes 17r, 17g, 17b in correspondence to the cells 3 of the respective colors on the line of the Z bus electrode 15. In the same manner, the Z electrode (Ze) at the reverse slit side has Z transparent electrodes 18r, 18g, 18b in correspondence to the cells 3 of the respective colors on the line of the Z bus electrode 16. Hereinafter, portions duplicated with the bus electrode in the respective transparent electrodes are put aside and only the protruding portions are considered.

The shape of the X, Y transparent electrodes 14, 13 in the cell 3 unit is the one that protrudes towards the both Z electrode sides opposing in the longitudinal direction, and in particular, the shape is I form (H form). Edges of the X, Y transparent electrodes 14, 13 opposing other electrodes are roughly in parallel with the lines of the respective bus electrodes 12, 11. The shape of the Z transparent electrodes 17, 18 in the cell 3 unit is the one that protrudes towards the X, Y electrodes sides opposing in the longitudinal direction, and in particular the shape of a rectangle. Edges of the Z transparent electrodes 17, 18 opposing other electrodes are roughly in parallel with the lines of the respective bus electrodes 15, 16. Edges of the X, Y transparent electrodes 14, 13 opposing other electrodes and edges of the Z transparent electrodes 17, 18 opposing thereto are roughly in parallel.

In the supposed technique, the size of the Z electrode in the respective cells is same. On the other hand, in the present embodiment, the sizes of the Z transparent electrodes 17, 18 of the adjacent cells 3 of the respective colors are made to be different. That is, the intervals (XZ, YZ) between the Z electrode and the X, Y electrodes for discharge are made to be different per cell 3.

The Z transparent electrodes 17, 18 are arranged for the improvement of adhesion of the Z bus electrodes 15, 16 as metal layers to the front substrate (glass substrate) 1 and for setting of spaces (gaps) for discharge to the X, Y electrodes, and the like. The Z transparent electrodes 17, 18 and the Z bus electrodes 15, 16 are used for, for example, a trigger discharge to a main discharge between the X, Y electrodes (XY).

In FIG. 4, in the row 4, intervals of electrodes in the cells 3 of the respective colors are shown. Meanwhile, the position of the address electrode 20 is omitted therein. The intervals (Dxy, Dxz, Dyz) of the respective bus electrodes between the X, Z, Y electrodes are constant across the full width of the panel. Further, particularly Dxz is equal to Dyz. Note that, Dxz and Dyz may be made different.

A distance d7 is the distance between the opposing edges of the X, Y transparent electrodes 14r, 13r between the XY in the cell 3 of R and is the gap where main discharge takes place. This is similar to distances d8, d9 in the cells 3 of G, B. These distances (d7 to d9) are roughly same (d7=d8=d9).

A distance d1 is the distance between the opposing edges of the X, Z transparent electrodes 14r, 17r between the XZ in the cell 3 of R and is the gap where trigger discharge and the like take place. This is similar to the distances d2, d3 in the cells 3 of G, B. A distance d4 is the distance between the opposing edges of the Y, Z transparent electrodes 13r, 17r between the XZ in the cell 3 of R and is the gap where a trigger discharge and the like take place. This is similar to the distances d5, d6 in the cells 3 of G, B. In the relation of these respective distances (d1 to d6), it stands that d1<d2<d3, d4<d5<d6. And, in particular, it stands that d1=d4, d2=d5, d3=d6. Meanwhile, d1 and d4, d2 and d5, d3 and d6 may be made to be different. In the present embodiment, the distances (d1, d4) of the discharge gap in the cell 3 of R as the color having a characteristic where the discharge voltage (firing voltage) becomes lowest are designed so as to be shortest, and on the contrary the distance at the cell 3 of B is designed so as to be widest.

Note that, with regard to the shape of the X, Y transparent electrodes 14, 13 in the cell 3 unit, other shapes may be employed as long as the distances (d1 to d9) satisfy the conditions. In the structure of the PDP 10, such an electrode structure of the cell 3 as described above is repeated in the same pattern in the lateral and longitudinal directions.

According to the above described electrode structure, in the cells 3 of the respective colors, relatively, the firing voltage of the distances (d1, d4) between the Z electrode and the X, Y electrodes is low in the cell 3 of R, and the firing voltage of the distances (d3, d6) between the Z electrode and the X, Y electrodes is high in the cell 3 of B, and that in the cell 3 of G is around the middle of these.

When a voltage is applied to between XZ or between YZ in the row 4, since the distances (d1, d4 and the like) of discharge gaps in the cells 3 of the respective colors R, G, B are different bit by bit, even if the application timing of the voltage is same, the discharge appearance timings are displaced bit by bit in the cells 3 of the respective colors. Even if the Driving Waveform from the driver side is same, it is possible to delay the discharge timing in the cells 3 of the respective colors and particularly an effect to improve the luminance of B can be expected.

<Driving Waveforms>

Next, as the operation of the PDP apparatus according to the first embodiment, a drive control of electrodes of the PDP 10 will be explained. The respective cells 3 of the PDP 10 can be turned ON/OFF selectively. The luminance of lighting cells 3 is changed, i.e., in order to perform grayscale display, the control by the well known subfield division is carried out. That is, one frame (field) is divided into a plurality of (10 or the like) subfields with specified weighting, and subfields to be turned ON in one frame per cell are combined, so that the grayscale display is performed.

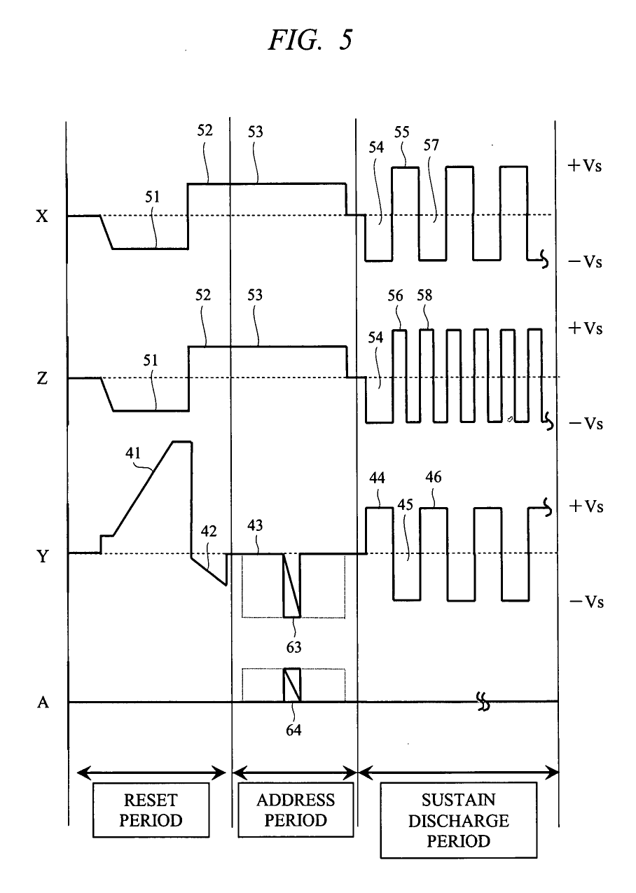

FIG. 5 is a diagram showing driving waveforms of one subfield in the PDP apparatus according to the first embodiment of the present invention. Sequentially, the waveforms of the voltage applied to the respective electrodes X, Z, Y, A are shown. In one subfield period, there are a reset period, an address period, a sustain discharge period (sustain period) in this order. The driving waveforms to the electrode group at the positive slit side will be explained.

At the first of the reset period, in the state where 0V is applied to the address electrode (A) 20, a negative reset pulse 51 whose voltage decreases gradually and then becomes constant is applied to the X, Z electrodes, and a positive reset pulse 41 whose voltage increases gradually after application of specified voltage is applied to the Y electrode. Thereby, in all the cells 3, a discharge first takes place between the Z electrode and the Y discharge electrode 13 (d4 and the like), and then it shifts to a discharge which takes place between the X, Y discharge electrodes 14, 13 (d7 and the like). Since what is applied herein is in a dull wave whose voltage changes gradually, a weak discharge and an electric charge formation are repeated, and wall charge is formed uniformly in all the cells 3. With regard to the polarity of the formed wall charge, the polarity in the vicinity of the X discharge electrode 14 and the Z electrode is positive polarity, and that in the vicinity of the Y discharge electrode 13 is negative polarity.

Next, a positive compensation voltage 52 (for example, +Vs) is applied to between the X discharge electrode 14 and the Z electrode (d1 and the like), and a compensation dull wave 42 whose voltage decreases gradually is applied to the Y electrode. Therefore, since a voltage of the polarity opposite to the wall charge formed as previously described is applied in a dull wave, due to weak discharges the wall charge in the cell 3 decreases. That is the end of the reset period, and all the cells 3 become in a uniform state.

Since the Z electrode is provided in the present embodiment, the distance (d2 and the like) between the Z electrode and the Y discharge electrode 13 is narrow, and by this discharge gap, a discharge takes place even with a low firing voltage. And with taking it as a trigger, it shifts to a discharge takes place in between the X, Y discharge electrodes 14, 13 (d7 and the like), and accordingly, it is possible to make the reset voltage to be applied to the X, Z electrodes and the Y electrode in the reset period small. Therefore, it is possible to reduce the luminance according to a reset discharge not related to display and improve the contrast.

In the next address period, the same voltage 53 as the compensation voltage 52 is applied to the X, Z electrodes and a specified negative voltage is applied to the Y electrode, and further a scan pulse 63 is applied sequentially. According to the application of the scan pulse 63, an address pulse 64 is applied to the address electrode 20 of an objective lighting cell. Therefore, a discharge takes place between the Y electrode to which the scan pulse is applied and the address electrode 20 to which the address pulse is applied, and with it as a trigger, a discharge takes place between the X and Z electrodes and the Y electrode. By this address discharge, at a vicinity of the X and Z electrodes negative wall charge is formed, and at a vicinity of the Y electrode positive wall charge is formed. Since the area of the Z electrode is smaller than that of the X electrode, the amount of the wall charge formed at the vicinity of the Z electrode is smaller than the amount of the wall charge formed at the vicinity of the X electrode. Further, at the Y electrode, positive wall charge equivalent to the wall charge amount to which the negative wall charge formed at the vicinity of the X and Y electrodes is formed. In the cell 3 to which the scan pulse or the address pulse is not applied, the address discharge does not take place, and accordingly the wall charge at the reset is maintained. In the address period, the scan pulse is applied to all the Y electrodes one after another and the above action is carried out, and an address discharge takes place in the objective lighting cells of the front of the panel surface. Note that, at the last of the address period, in the cells 3 where the address discharge does not take place, a pulse to adjust the wall charge formed in the reset period is applied in some cases.

Next, in the sustain period, first a negative sustain discharge pulse (sustain pulse) 54 of a voltage −Vs is applied to the X and Z electrodes, and a positive sustain pulse 44 of the voltage +Vs is applied to the Y electrode. In the cells 3 where the address discharge is carried out, the voltage according to the positive wall charge formed at the vicinity of the Y electrode is superimposed to the voltage +Vs, and the voltage according to the negative wall charge formed at the vicinity of the X and Z electrodes is superimposed to the voltage −Vs. Therefore, first, between the Z, Y electrodes with a narrow gap (d4 and the like), a discharge is started, and with this discharge as a trigger, a discharge takes place between the X, Y electrodes with a wide gap (d7 and the like). The discharge between the X, Y electrodes is a long-distance discharge and is a discharge with a preferable light emission efficiency. With regard to this discharge, among the charges generated by discharge, positive wall charge is accumulated as wall charge at the vicinity of the X and Z electrodes, negative charge is accumulated as wall charge at the vicinity of the Y electrode, and the voltage according to wall charge is converged by decreasing the voltage between the X and the Z electrodes and the Y electrode (referred to as state a). When the voltage is converged, positive wall charge is formed at the vicinity of the X and Z electrodes, and negative wall charge is formed at the vicinity of the Y electrode. Note that, in the cells 3 where the address discharge is not carried out, the above discharge does not take place and a discharge does not take place in the sustain period, and thus explanations are omitted. Further, in the present embodiment, since in the cells 3 of the respective colors the intervals between the Z electrode and X, Y discharge electrodes 14, 13 are different, there occurs a difference in the firing timings. This will be described later.

Next, a positive sustain pulse 55 of the voltage +Vs is applied to the X electrode and a negative sustain pulse 45 of the voltage −Vs is applied to the Y electrode, and a pulse 56 that changes into the voltage +Vs and then changes into the voltage −Vs in a short time is applied to the Z electrode. Thus, the voltage by the negative wall charge formed at the vicinity of the Y electrode is superimposed to the voltage −Vs, and the voltage according to the positive wall charge formed at the vicinity of the X and Z electrodes is superimposed to the voltage +Vs. Therefore, first, a discharge is started between the Z, Y electrodes (d4 and the like), and with this discharge as a trigger, it shifts to a discharge takes place between the X, Y electrodes (d7 and the like) with a wide gap. Just after this, the voltage to be applied to the Z electrode changes from +Vs to −Vs, and the discharge stops between the Z, Y electrodes. The discharge between the X, Y electrodes stops when negative charge is accumulated as wall charge at the vicinity of the X electrode and positive electric charge is accumulated as wall charge at the vicinity of the Y electrode. But at this moment, −Vs is applied to the Z electrode and thus positive wall charge is formed at the vicinity of the Z electrode. Accordingly, when the voltage is converged, negative wall charge is formed at the vicinity of the X electrode and positive wall charge is formed at the vicinity of the Y electrode and the Z electrode.

Next, a negative sustain pulse 57 of the voltage −Vs is applied to the X electrode, a positive sustain pulse 46 of the voltage +Vs is applied to the Y electrode, and a pulse 58 that changes into the voltage +Vs and then changes into the voltage −Vs in a short time is applied to the Z electrode. Therefore, the voltage according to the negative wall charge formed at the vicinity of the X electrode is superimposed to the voltage −Vs, and the voltage according to the positive wall charge formed at the vicinity of the Y and Z electrodes is superimposed to the voltage +Vs. Consequently, first, a discharge is started between the Z, X electrodes (d1 and the like), and with this discharge as a trigger, it shifts to a discharge takes place between the X, Y electrodes (d7 and the like) with a wide gap. Just after this, the voltage to be applied to the Z electrode changes from +Vs to −Vs, and the discharge stops between the Z, Y electrodes. But at this moment, since −Vs is applied to the Z electrode, positive wall charge is formed at the vicinity of the Z electrode. Therefore, when the voltage is converged, positive wall charge is formed at the vicinity of the X and Z electrodes and negative wall charge is formed at the vicinity of the Y electrode. In other words, the state gets back to the above-said state a. Hereinafter, in the same manner as the above, positive and negative sustain pulses are applied alternately between the X, Y electrodes, and in sync with the application of the sustain pulses, a pulse with a narrow lateral width is applied to the Z electrode so that the same actions as the above are repeated and the sustain discharges are repeated. By application of a specified number of pulses per subfield, the sustain discharge period is terminated.

<Discharge Timing, Current and Voltage>

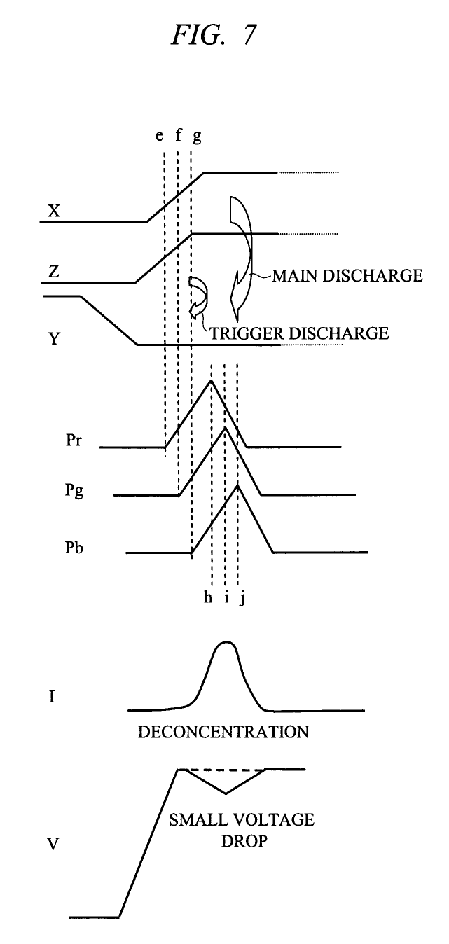

Next, with reference to FIG. 6 and FIG. 7, as an effect by a structure where electrode gaps are made different in cells 3 of the respective colors, discharge timing, and current concentration and voltage drop at the moment of the discharge timing are explained hereinafter.

FIG. 6 shows conditions of one time of sustain discharge between the X discharge electrode and the Y discharge electrode in a 3-electrode PDP as a supposed technique where the Z electrode is not arranged and with a structure where gaps of opposing edges of the X, Y electrodes are same in all the cells. From the top, a driving waveform of the X electrode, a driving waveform of the Y electrode, a main discharge between XY (referred to as P), a current (I) flowing in the X, Y electrodes, and a voltage (V) in the X, Y electrodes are shown therein.

FIG. 7 shows conditions of one time of sustain discharge between the X discharge electrode 14, the Y discharge electrode 13, and the Z discharge electrode 17 in cells 3 of the respective colors according to the first embodiment, in the same manner as in FIG. 6. From the top, driving waveforms in the respective electrodes X, Z, Y, main discharges between XY in the respective cells 3 of R, G, B (referred to as Pr, Pg, Pb), a current (I) flowing in the X, Y electrodes, and a voltage (V) of the X, Y electrodes are shown therein.

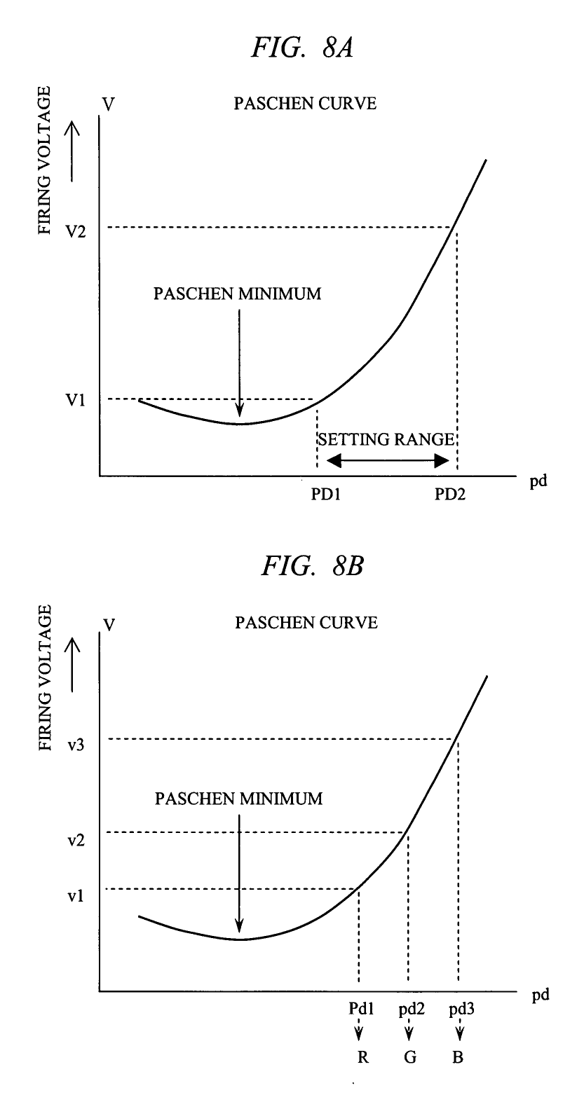

Further, FIGS. 8A, 8B show Paschen curves and a setting range of design specifications in the present embodiment of the present invention. FIG. 8A shows a condition of the setting range and FIG. 8B shows a setting example in the case where the settings of firing voltage (that is, discharge gap) are made to be different particularly in the plurality of cells 3 in the setting range of FIG. 8A.

In the structure of the supposed technique, since a distance d of the opposing edges of the X discharge electrode and the Y discharge electrode is same in all the cells and the gas pressure p is same in all the cells, the product of the gas pressure p and the distance d is identical in all the cells. Accordingly, in the Paschen curve of FIG. 8A, the product pd is one value, and the firing voltages of all the cells are same. Consequently, as shown in FIG. 6, the sustain discharge (P) between the X, Y discharge electrodes is started at the same timing in all the cells, and the discharge intensity increases in the same manner. Therefore, the current (I) supplied from the X driver and the Y driver increases steeply at the peak of the discharge (P). This steeply increasing current (I) flows in the X and Y electrodes causes the voltage (V) applied to the respective ends of the X and Y electrodes instantaneously decrease greatly due to voltage drop. Therefore, in part of the cells, the discharge intensity decreases and the discharge is not carried out normally, and other problems occur.

In FIG. 6, at the timing in the course of rising of applied pulse of the X electrode, the main discharge (P) at the XY is started. For this main discharge (P), it is necessary to apply the current (I) from the driver side to the X, Y electrodes. In proportion with the current (I), the voltage drop is severe. The above current concentration and voltage drop become further larger for making many cells emit light on the display screen of the PDP 10, that is, when the display load ratio is large.

On the other hand, in FIG. 7, in the present first embodiment, according to the structure where intervals of respective gaps (discharge gaps) of the transparent electrodes of the cells 3 of the respective colors are different, in the application of voltage to the X, Z, Y electrodes, first, the start timing of trigger discharge in ZY or ZX gets delayed. Symbols e, f, g indicate the start timings of trigger discharges in the cells 3 of R, G, B, respectively. In the course of rising of the applied pulse of the X electrode, a trigger discharge is started in the sequence of R, G, B. These respective trigger discharges shift to a main discharge at XY. Symbols h, i, j indicate peak timings of the main discharges (Pr, Pg, Pb) in the cells 3 of R, G, B, respectively. Since the timings of the above trigger discharges are delayed, the timings of the main discharge are delayed as well. Since the timings of the respective main discharges are delayed, the current (I) is deconcentrated (alleviation of concentration) as well. Therefore, the amount of voltage drop in the voltage (V) decreases as well.

In the above FIG. 7, after the voltage to be applied to the Y electrode is lowered, the voltages to be applied to the Z and X electrodes are increased. Herein, the voltage to be applied to the Z electrode is raised a bit faster than the voltage to be applied to the X electrode. Along the increase of voltage to be applied to the Z electrode, first at the time point of e, in the cell 3 of R, the voltage between the Z electrode and the Y discharge electrode 13r exceeds the firing voltage v1 and a trigger discharge between them is started. Next, at the time point of f, in the cell 3 of G, similarly the voltage between the Z electrode and the Y discharge electrode 13g exceeds the firing voltage v2 and a trigger discharge is started. Further next, at the time point of g, in the cell 3 of B, similarly the voltage between the Z electrode and the Y discharge electrode 13b exceeds the firing voltage v3 and a trigger discharge is started between them. In this manner, on the panel surface of the PDP 10, trigger discharges are started in the sequence of the cells 3 of the respective colors R, G, B. Since these time differences are very small, it cannot be recognized by the naked eye.

As the trigger discharge is started between the Z electrode and the Y discharge electrode 13, in the cells 3 of the respective colors, with bit displaced timings, main discharges (Pr, Pg, Pb) between the X discharge electrode 14 and the Y discharge electrode 13 are started. Accordingly, with regard to the timings (h, i, j) of the peak values of the respective main discharges (Pr, Pg, Pb), the discharge intensity of the main discharge Pr in the cell 3 of R becomes the peak value earliest at h, and then at i, j, the main discharges Pg, Pb become peak values in the same manner.

As described above, since the sustain discharges (Pr, Pg, Pb) between the X discharge electrode 14 and the Y discharge electrode 13 are started at different timings, and the timings at which the discharge intensity becomes the peak value are different, the current (I) supplied from the X driver and the Y driver to the respective electrodes is deconcentrated, and does not increase rapidly. Accordingly, the amount of voltage drop of the voltage (V) applied to the respective ends of the X, Y electrodes is reduced more than that in the supposed technique.

In FIG. 7 shows the case where the voltage to be applied to the Z electrode is changed in the same manner as the voltage to be applied to the X electrode and a trigger discharge takes place between the Z electrode and the Y discharge electrode 13. However, the present invention is not limited to this, but this is same to the case where a trigger discharge takes place between the Z electrode and the X discharge electrode 14.

In FIG. 8A, in the first embodiment, in the range above the Paschen minimum of the Paschen curve, the product pd and the setting range of firing voltage (PD1-PD2, V1-V2) are determined. It is known that in the case when a discharge gas is filled in a discharge space and a discharge is made between two electrodes, the threshold voltage of discharge (firing voltage) is determined according to the product of the distance d between the two electrodes and the pressure p of the discharge gas. The curve to show the change is the Paschen curve. The firing voltage becomes the minimum value when the product pd is a certain value and the state is called the Paschen minimum.

Further as shown in FIG. 8B, in the setting range of FIG. 8A, firing voltages are set different in the cells 3 of the respective colors R, G, B. In the present embodiment, setting is made so that the firing voltage becomes higher in the sequence of R, G, B. That is, the electrode structure with d1<d2<d3 in FIG. 3 is made so that the distance of discharge gap becomes shorter in the sequence of R, G, B. Since the gas pressure p is same in all the cells, the product pd of the distance d1 and the like of opposing edges of the Z electrode and the X discharge electrode 14 and the gas pressure p is at the position shown by pd1 in the cell 3 of R, at the position shown by pd2 in the cell 3 of G, and at the position shown by pd3 in the cell 3 of B. The corresponding firing voltages in the respective cells 3 become v1, v2, v3.

### Second Embodiment

Next, as the other embodiment according to the present invention, a second embodiment is described. The outline of a PDP apparatus of the second embodiment is as describe below. The second embodiment has a structure having Z electrodes whose shape is different from that of the first embodiment. In the second embodiment, the shape of discharge electrode of the Z electrode per cell is made into a rectangular triangle, that is, a shape where a specified angle is made by a line (first direction) of bus electrode and an edge of an opposing electrode. In the line (first direction) of the bus electrode, there is formed a saw-teeth shape where a pattern of protruding portions of rectangular triangles in different sizes is arranged.

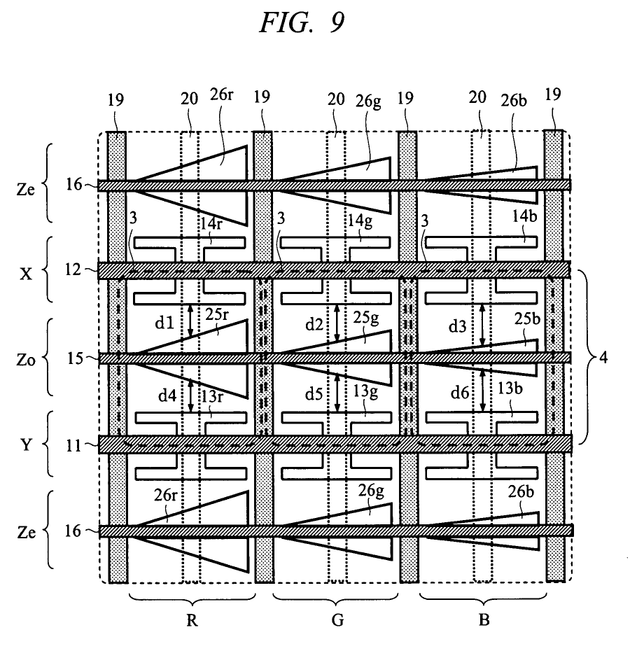

FIG. 9 shows the structure of the cells 3 of the PDP 10 in the second embodiment in the same manner as in FIG. 3. In the second embodiment, the shapes of Z discharge electrodes 25 {25r, 25g, 25b} (positive slit side), 26 {26r, 26g, 26b} (reverse slit side) of the cells 3 of the respective colors R, G, B are different from the first embodiment. In the respective Z discharge electrodes 25, 26 have its protruding portions from the Z bus electrodes 15, 16 in rectangular triangle shapes, and whose edges thereof form specified angles with edges of the respective bus electrodes and opposing X, Y discharge electrodes 14, 13, which is 45 degrees or below in the present embodiment. Further, in the same manner as in the first embodiment, in the cells 3 of the respective colors, distances (d1 to d3 and d4 to d6) of gaps (XZ, YZ) of the respective discharge electrodes are set to be different. The driving waveforms, discharge conditions, setting range and the like are same as those in the first embodiment.

According to the above electrode structure, since the distances of discharge gaps in the cells 3 of respective subpixels are different in the lateral direction, an effect to cope with the unevenness problem of between the cells 3 that occurs inevitably in manufacture is expected.

### INDUSTRIAL APPLICABILITY

The present invention is applicable to a panel, a flat display apparatus and the like for performing discharge between first to third electrodes.

1. A plasma display panel comprising:
a first substrate; and a second substrate which is arranged so as to oppose the first substrate and forms a discharge space filled with a discharge gas between the first substrate and itself,
wherein the first substrate comprises:
a plurality of first electrodes and second electrodes alternately arranged roughly in parallel so as to expand in a first direction;
a plurality of third electrodes arranged between the first electrodes and the second electrodes; and
a dielectric layer covering the first, second and third electrodes,
wherein the second substrate comprises
a plurality of fourth electrodes arranged in a second direction so as to cross the first, second and third electrodes,
wherein, between the first and the second substrates, it comprises:
a barrier rib sectioning the first direction in a plurality of cells; and
phosphor layers of a plurality of colors applied separately between the barrier ribs, and
wherein, in the respective cells, an interval of the first electrode and the second electrode is roughly constant, and
in at least a cell of one color of the cells of the respective plurality of colors, intervals between the first electrode, the second electrode and the third electrode are made to be different from those between the first electrodes, the second electrodes and the third electrodes in the cells of other colors.

2. The plasma display panel according to claim 1,
wherein the third electrode is structured to include a third transparent electrode which transmits visible light and a third bus electrode in a straight-line shape whose resistance value is lower than that of the third transparent electrode,
the third transparent electrode has a shape where an edge opposing the first electrode and the second electrode of a protruding portion towards the second direction from the line of the third bus electrode is roughly in parallel with edges of the first and the second electrodes, and
the protruding portions of the third transparent electrodes in the cells of the respective plurality of colors are rectangular, and lengths thereof in the second direction are different.

3. The plasma display panel according to claim 1,
wherein the third electrode is structured to include a third transparent electrode which transmits visible light and a third bus electrode in a straight-line shape whose resistance value is lower than that of the third transparent electrode,
the third transparent electrode has a shape where an edge opposing the first electrode and the second electrode at a protruding portion towards the second direction from the line of the third bus electrode has a prescribed angle with edges of the first and the second electrodes, and
the protruding portions of the third transparent electrode in the cells of the respective plurality of colors is rectangular triangle, and the angles are different.

4. The plasma display panel according to claim 1,
wherein, in the cells of the respective plurality of colors, intervals between the first and second electrodes and the third electrode in a cell of red having a characteristic that whose discharge voltage is lowest are made to be narrower than intervals between the first and second electrodes and the third electrode in the cells of other colors.

5. The plasma display panel according to claim 1,
wherein, in the cells of the respective plurality of colors, intervals between the first and second electrodes and the third electrode in a cell of blue are made to be wider than intervals between the first and second electrodes and the third electrode in the cells of other colors.

6. The plasma display panel according to claim 1,
wherein the dielectric layer provided in the first substrate is formed of a silicon compound formed by chemical vacuum deposition.

7. The plasma display panel according to claim 1,
wherein a thickness of the dielectric layer provided in the first substrate is about 3 μm or more to 25 μm or below.

8. The plasma display panel according to claim 1,
wherein the discharge gas has a composition including at least Ne and Xe, and a mixture rate of the Xe is made to be 10% or more to 30% or below.

9. A plasma display apparatus comprising
the plasma display panel according to claim 1, and
a driver circuit which drives the respective electrodes of the plasma display panel,
wherein, in the respective cells, an interval between the first and second electrodes is roughly constant,
in the cells of at least a cell of one color of the respective plurality of colors, the intervals between the first and second electrodes and the third electrode are made to be different from that between the first and second electrodes and the third electrode in the cells of other colors, and
a voltage for sustain discharge is applied from the driver circuit to the first, second and third electrodes from the driver circuits, and discharge timings in the intervals between the first and second electrodes and the third electrode are delayed in the cells of the respective plurality of colors.
